(19) United States
(12) Patent Application Publication
(10) Pub. No.: US 2011/0307224 A1
(43) Pub. Date: Dec. 15, 2011

(54) System and Method for Machine Engine Modeling

(75) Inventor: Michael Schlereth, Wilhermsdorf (DE)

(73) Assignee: Siemens Product Lifecycle Management Software Inc., Plano, TX (US)

(21) Appl. No.: 12/797,685

(22) Filed: Jun. 10, 2010

(51) Int. Cl. G06F 17/50

(52) U.S. Cl. 703/1

(57) ABSTRACT

A system, method, and computer readable medium. A method includes maintaining a domain-specific library that has machine objects for a specific usage domain. The method includes building a machine engine model using machine objects from the domain-specific library, where the machine engine model defines at least one automation task. The method includes executing the automation task according to the machine engine model and the plurality of machine objects and displaying the machine engine model, including the executing automation task.

### CROSS-REFERENCE TO OTHER APPLICATION

This application includes subject matter similar to that of concurrently-filed, commonly assigned U.S. patent application Ser. No. ______ for “System and Method for Physics-Oriented System Configuration”, which is hereby incorporated by reference.

### TECHNICAL FIELD

The present disclosure is directed, in general, to systems and methods for use in computer-aided design, manufacturing, using, modeling, and visualization (individually and collectively, “CAD” and “CAD systems”) and in product lifecycle management (“PLM”) and other systems.

### BACKGROUND OF THE DISCLOSURE

Many manufactured products are first designed and modeled in CAD systems, and PLM systems are used my manufacturers, retailers, customer, and other users to manage the design, use, and disposal of various products. Improved systems are desirable.

### SUMMARY OF THE DISCLOSURE

Various embodiments include systems, methods, and computer readable mediums. One disclosed method includes maintaining a domain-specific library that has machine objects for a specific usage domain. The method includes building a machine engine model using machine objects from the domain-specific library, where the machine engine model defines at least one automation task. The method includes executing the automation task according to the machine engine model and the plurality of machine objects and displaying the machine engine model, including the executing automation task.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of a system in accordance with disclosed embodiments; and

FIG. 3 depicts a high-level flowchart of a process in accordance with disclosed embodiments.

### DETAILED DESCRIPTION

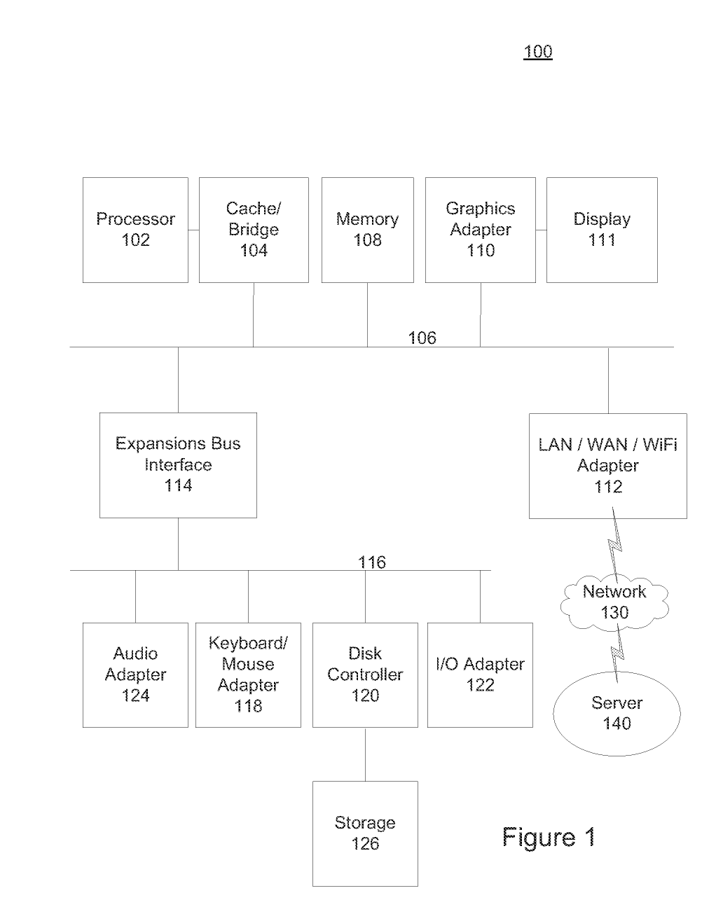

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In the early engineering phases of developing machines and systems processes, the machine concept is generally created in the form of machine sketches or graphically in the form of a CAD or PLM model. In many cases, to create corresponding automation and simulation systems, the machine concept must be manually translated by engineers into the programming languages of the automation or simulation system. In other cases, such as describing automation tasks for automation engineering and simulation, other languages can be used, such as abstract, graphical, or text-oriented programming languages.

The use of these programming languages requires that the engineers have be highly skilled in abstraction with respect to the stated automation task, artifacts from the mechanical construction, and the requirement specifications. In addition, as a rule this abstraction process must be performed multiple times, for example because the programming languages for automation engineering and simulation are usually different.

Disclosed embodiments include systems and methods for more effective machine engine modeling to simulate machine behavior and for other purposes.

FIG. 1 depicts a block diagram of a data processing system in which an embodiment can be implemented, for example when configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods for creation of a machine engine model. Various systems can use machine-description data, and automatically identify machine-specific or automation-specific objects, such as tool changers, spindles, motors, and other objects. These behavior and interoperation of these objects can be predefined automatically with physical properties and physical behavior, and the system uses these to build a machine engine model that models the overall machine including the use of the identified objects. The system performs automatic recognition of objects in available machine-description data material, and after building the model, the identified objects then also behave in the model and simulation like the corresponding physical object. In some embodiments, the knowledge of how to simulate the identified objects is implemented in Machine Execution Engine 210. For example, the knowledge about the behavior of a gearing can be implemented in the Machine Execution Engine 210. The machine model holds the specific properties of a gearing that can be simulated be the machine execution system.

The systems and methods disclosed herein provide distinct technical advantages over known systems, by allowing the modeled engine to more accurately and effectively simulate the corresponding physical systems, for direct interaction with the simulation or for building or managing a corresponding physical system.

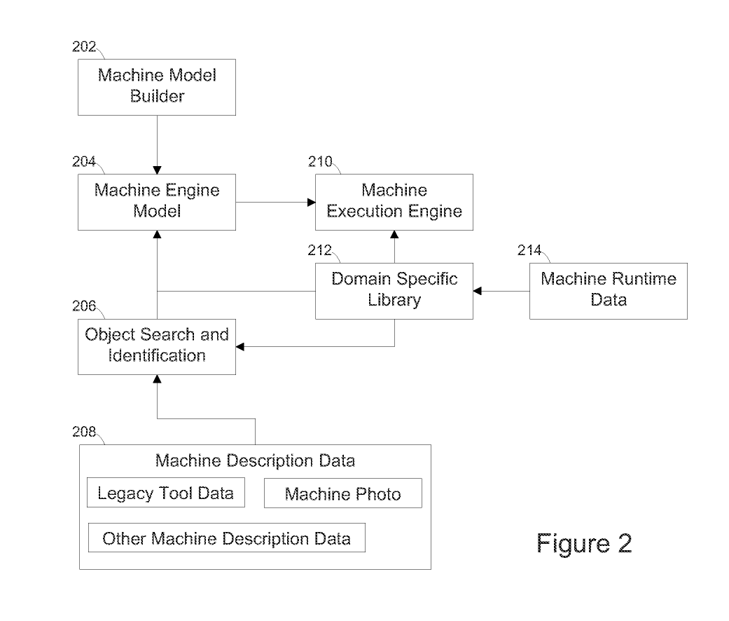

FIG. 2 depicts a block diagram of a system in accordance with disclosed embodiments, as can be implemented for example by one or more data processing systems 100 acting together.

The core elements of a system as disclosed herein include a machine engine model 204, a domain specific library 212, and a machine execution engine 210. A domain specific library, in this context, is a library that includes machine objects and elements, along with any corresponding CAD, PLM, operational, or other data, for a machine in a specific usage domain, including an automation domain, such as automotive, industrial, fluid or cloth handling, or otherwise, and including a physical environment domain that describes the objects a specific simulated physical environment domain and the ways in which they can interact.

The domain specific library 212 includes the properties of an object needed by the machine execution engine 210 to simulate the behavior of these objects. By the separation of object properties, which can be stored in the machine model 204, and the simulation algorithms, which can be implemented in the machine execution engine 210, it is possible to use different machine execution engines on the same machine model. For example, this provides the advantage of enabling different machine execution engines to execute a simulation on different levels of detail, or can enable game engines to operate with different simulation behavior on the same game scene. By using a library that is specific to a domain, the recognition processes described herein can operate more efficiently. Of course, those of skill in the aft will recognize that the defined “domain” can be more or less specific as required for particular implementations.

The machine engine model 204 describes the machine and its automation task, and the machine execution engine 210 displays and simulates the machine and its automation task. Also, or alternately, these can display a “scene” such as a simulated environment including automated machinery environments, simulated physical environments such as in a game or otherwise, or other simulated environment, and this environment can function as the “domain”. In contrast to existing systems, the automation task is not described in the form of a programming language, but instead in the form of a model built from elements of a domain specific library 212. The data properties of this model can be used by implementations of a machine execution engine 210 that can simulate the automation task or other physical relationships and interactions according the desired analysis aspects, e.g. with respect to stiffness or with respect to kinematic motion. The machine engine model 204 can be, e.g., a full graphical 3D model or a higher-level abstract model in the form of elements or objects as described by the domain specific library 212 and their relationships with each other. Because, in some embodiments, only elements from the domain specific library 212 are used, the system can build a model very quickly and easily, with or without the interaction from a user.

In some embodiments, a machine engine model 204 can be created only within the specified framework of the domain specific library 212. In these cases, additional, alternative, or other elements can be added to the model by the creation of new library elements for domain specific library 212.

In the domain specific library 212, library elements can be represented in various ways, e.g., graphically for the processing of the machine engine model 204, as a search pattern (e.g., with tags) for identification, or as a state machine for execution. In special cases, these representations can be identical, e.g., the graphical shape is used for the simulation as engineering, runtime, and search representations. The library elements are included in the domain specific library 212 for a certain machine type. The parameters of these elements are taken from machine engineering and as a rule deviate from the parameters of a real, constructed machine. In order that the machine engine model 204 and machine execution engine 210 models the parameters of the corresponding physical systems as realistically as possible, machine runtime data 214, such as the parameter set from a one or more physical certain machines, can be preloaded as part of the machine objects in the domain specific library 212 or as modifications to or parameters of those objects. The machine execution engine 210 needs not to use all detail parameters of the machine model but can, for example, only work on a subset of the parameters for performance reasons if appropriate for the machine analysis.

The machine execution engine 210 receives the created machine engine model 204 and the required objects from the domain specific library 212, such as runtime representations of the library elements being used, and executes the automation task defined by the machine execution model 204. The execution of the automation task here can include, e.g., a simulation of the machine mechanics/machine physics, simulation of a control task for sensors or actuators in the machine engine model 204, and other simulation and visualization tasks.

The machine engine model 204 can be created either manually with a machine model builder 202 via an interaction with a user, or automatically by means of an object search and identification process 206.

For manual creation, library elements can be selected from the domain specific library 212 and placed into the machine engine model 204, for example, via an interaction with a user. Here, placement can include a geometric placement in the sense of a 3D model or the placement in an abstract machine model, e.g., in a module graph.

For automated creation, machine description data 208 can be used. This can include a machine description or other data created in a legacy tool, such as a CAD program. In this CAD representation, for example, shapes can be identified by the object search and identification process 206, and inserted into the machine engine model 204. For such object search and identification, a product such as the Geolus Search shape-based search machine software product from Siemens Product Lifecycle Management Software Inc. can be used.

Alternately, for the creation of a simulation of an already existing physical/mechanical machine, one or more photos of the machine or a three-dimensional scan could also be used as the machine description data 208. The automated creation can also be combined, e.g., for post-processing or expansion, with manual input.

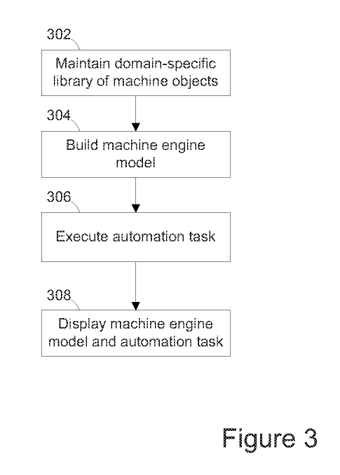

FIG. 3 depicts a high-level flowchart of a process in accordance with disclosed embodiments, as described in more detail above.

The system maintains a domain-specific library of machine objects and other data that correspond to a specific usage domain (step 302).

The system builds a machine engine model using at least some of the machine objects and other data from the domain-specific library (step 304). The machine engine model defines at least one automation task, simulated physical interaction, or other interaction between the machine objects. This step can include an interaction with a user to interactively build the model. The machine engine model can simulate an interaction of the physical objects in a computer-generated physical environment.

Further, as described above, this step can include an automated or interactive process to automatically receive machine description data, recognize objects of the machine description data, and identify machine objects of the domain-specific library that correspond to the recognized objects. “Receiving”, as used herein, can include loading from storage, receiving from another data processing system such as over a network, receiving through an interaction with a user, or otherwise. The machine description data can include computer aided design data of a machine to be modeled, a photograph/3D scan of a machine to be modeled, or other data.

The system executes an automation task according to the machine engine model and the machine objects (step 306). In this step, the system can show a simulation of the machine engine model and its machine objects. This step can include a simulation of physical interactions according to the machine engine model, or other simulations or animations of the model. This step can include attaching an exchangeable machine execution engine to the machine engine model to perform this execution. In various embodiments, the machine execution engine knows how to simulate machine objects with a property set for a specific kind of simulation/analysis.

The system displays the machine engine model and executing automation task to a user (step 308).

Embodiments described herein can be used, for example, for the transfer of design concepts from game programming to automation technology. The focus of game development no longer lies on the specialized programming of the game script by engineers, but instead on the creation of the script and the game scenes directly by the game designer, which can then be acted upon as a machine engine model. Through the construction of the machine engineering and, the simulation from machine scenes, the machine designer can describe his concepts directly (either in the role of the designer or in the role of the client) just like a game designer, with these concepts able to be implemented directly without diversion to an automation programmer or simulation specialist. The execution of the game done can be performed by a “game engine” which knows how to handle the elements and functions as the machine execution engine described herein, thus allows a game designer is allowed to use the game scene described above as the physical environment to be simulated.

Combination of pattern identification concepts described herein, such as object search and identification process 206 with a domain-dependent solution space in the form of the domain specific library 212 for automated scene creation from existing data material.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
maintaining a domain-specific library in a data processing system, the domain-specific library including machine objects for a specific usage domain;
building a machine engine model by the data processing system using a plurality of machine objects from the domain-specific library, the machine engine model defining at least one automation task;
executing the at least one automation task by the data processing system, according to the machine engine model and the plurality of machine objects; and
displaying the machine engine model, including the executing at least one automation task, by the data processing system.

2. The method of claim 1, wherein building the machine engine model includes an interaction with a user.

3. The method of claim 1, wherein building the machine engine model includes receiving machine description data, recognizing objects of the machine description data, and identifying machine objects of the domain-specific library that correspond to the recognized objects.

4. The method of claim 3, wherein the machine description data includes computer aided design data of a machine to be modeled.

5. The method of claim 3, wherein the machine description data includes a photograph of a machine to be modeled.

6. The method of claim 1, wherein executing the at least one automation task is performed by a machine execution engine based on the properties of the objects in the machine engine model and includes a simulation of physical interactions according to the machine engine model.

7. The method of claim 1, wherein a machine execution engine simulates an interaction of a plurality of physical objects in a computer-generated physical environment based on the properties of the physical objects and on the machine engine model.

8. A data processing system comprising a processor and accessible memory, the data processing system particularly configured to perform the steps of:
maintaining a domain-specific library in a data processing system, the domain-specific library including machine objects for a specific usage domain;
building a machine engine model by the data processing system using a plurality of machine objects from the domain-specific library, the machine engine model defining at least one automation task;
executing the at least one automation task by the data processing system, according to the machine engine model and the plurality of machine objects; and
displaying the machine engine model, including the executing at least one automation task, by the data processing system.

9. The data processing system of claim 8, wherein building the machine engine model includes an interaction with a user.

10. The data processing system of claim 8, wherein building the machine engine model includes receiving machine description data, recognizing objects of the machine description data, and identifying machine objects of the domain-specific library that correspond to the recognized objects.

11. The data processing system of claim 10, wherein the machine description data includes computer aided design data of a machine to be modeled.

12. The data processing system of claim 10, wherein the machine description data includes a photograph of a machine to be modeled.

13. The data processing system of claim 8, wherein executing the at least one automation task is performed by a machine execution engine based on the properties of the objects in the machine engine model and includes a simulation of physical interactions according to the machine engine model.

14. The data processing system of claim 8, wherein a machine execution engine simulates an interaction of a plurality of physical objects in a computer-generated physical environment based on the properties of the physical objects and on the machine engine model.

15. A computer-readable storage medium encoded with computer-executable instructions that, when executed, cause a data processing system to perform the steps of:
maintaining a domain-specific library, the domain-specific library including machine objects for a specific usage domain;
building a machine engine model using a plurality of machine objects from the domain-specific library, the machine engine model defining at least one automation task;
executing the at least one automation task according to the machine engine model and the plurality of machine objects; and
displaying the machine engine model, including the executing at least one automation task.

16. The computer-readable storage medium of claim 15, wherein building the machine engine model includes an interaction with a user.

17. The computer-readable storage medium of claim 15, wherein building the machine engine model includes receiving machine description data, recognizing objects of the machine description data, and identifying machine objects of the domain-specific library that correspond to the recognized objects.

18. The computer-readable storage medium of claim 17, wherein the machine description data includes computer aided design data of a machine to be modeled.

19. The computer-readable storage medium of claim 17, wherein the machine description data includes a photograph of a machine to be modeled.

20. The computer-readable storage medium of claim 15, wherein executing the at least one automation task is performed by a machine execution engine based on the properties of the objects in the machine engine model and includes a simulation of physical interactions according to the machine engine model.

21. The computer-readable storage medium of claim 15, wherein a machine execution engine simulates an interaction of a plurality of physical objects in a computer-generated physical environment based on the properties of the physical objects and on the machine engine model.
